(19) United States
(12) Patent Application Publication
(10) Pub. No.: US 2020/0284909 A1
(43) Pub. Date: Sep. 10, 2020

(54) DISTANCE MEASURING SENSOR AND DISTANCE MEASURING METHOD

(71) Applicant: SHARP KABUSHIKI KAISHA, Sakai City (JP)

(72) Inventor: SHIGEO OHYAMA, Sakai City (JP)

(21) Appl. No.: 16/807,964

(22) Filed: Mar. 3, 2020

Related U.S. Application Data
(60) Provisional application No. 62/815,950, filed on Mar. 8, 2019.

(51) Int. Cl. G01S 17/34; G01S 7/4914; G01S 7/4911

(52) U.S. Cl. CPC G01S 17/34; G01S 7/4911; G01S 7/4914

(57) ABSTRACT

A TOF-system distance measuring sensor comprises: a light source unit that radiates light to a target as the irradiation light, the light being subjected to primary modulation so that the distance to the target can be measured and being subjected to secondary modulation so that influences of disturbance light are reduced; and a light receiving unit that receives the reflection light subjected to the secondary modulation and that subjects the reflection light subjected to the secondary modulation to secondary demodulation so that influences of disturbance light are reduced.

### TECHNICAL FIELD

The disclosure relates to a distance measuring sensor and a distance measuring method.

### BACKGROUND ART

A method using a time-of-flight system (a TOF system) distance measuring sensor is available as a method for measuring a distance to a target by using light. The TOF-system distance measuring sensor measures a distance to a target by measuring a propagation time of light from when irradiation light is radiated to the target until reflection light is received. In general, in order to facilitate the measurement of a distance to a target, the distance measuring sensor radiates modulated light to the target as irradiation light and calculates the distance to the target by using a phase difference between the irradiation light and reflection light reflected by the target.

For a modulation cycle T, an irradiation-light modulation wave (an irradiation modulation wave), which is expressed by equation (1) below, and a reflection-light modulation wave (a reflection modulation wave), which is expressed by equation (2) below, are described below. Although the light is modulated in this case so as to have a sine wave indicated by equation (1) below, the light may also be modulated so as to have a pulse wave.

y(t)=a sin(ωt)+b (1)

Y(t)=A sin(ωt−θ)+B (2)

Here, a in equation (1) is the amplitude of the irradiation modulation wave, and b is offset of the irradiation modulation wave. A in equation (2) is the amplitude of the reflection modulation wave, B is offset of the reflection modulation wave, and θ is a phase difference. Also, ω in equations (1) and (2) is 2π/T.

The modulation cycle T needs to be set according to a largest measurement distance to the target. Equation (3) below indicates the relationship between a largest measurement distance Lₘₐₓ and the modulation cycle T.

Lₘₐₓ=cT/2 (3)

Here, c is the speed of light and is about 3×10⁸ m/s.

The distance measuring sensor receives the reflection light by sampling the reflection modulation wave every T/4.

FIG. 1 shows a graph showing the relationship between the modulation cycle T of an irradiation modulation wave α and a reflection modulation wave β and light intensities (signal intensities) A0, A1, A2, and A3. Equations (4) to (7) below indicate the light intensities A0, A1, A2, and A3 of the reflection modulation wave β at T=0, T=π/4, T=π/2, and T=3π/4, respectively.

A0=Y(0)=−A sin(θ)+B (4)

A1=Y(T/4)=A sin(π/2−θ)+B=A cos(θ)+B (5)

A2=Y(T/2)=A sin(π−θ)+B=A sin(θ)+B (6)

A3=Y(3T/4)=A sin(3π/2−θ)+B=−A cos(θ)+B (7)

When the amplitude A of the reflection modulation wave β and the offset B of the reflection modulation wave β, the amplitude A and the offset B being constants, are deleted from equations (4) to (7), equation (8) below is obtained.

A2−A0/A1−A3=2A sin(θ)/2A cos(θ) (8)

From equation (8), the phase difference θ can be determined using A0, A1, A2, and A3, as in equation (9) below.

θ=arctan(A2−A0/A1−A2) (9)

Hence, using the phase difference θ in equation (9), a distance L to the target can be calculated as in equation (10) below.

L=Lₘₐₓ×θ/2π=cTθ/4π (10)

As is apparent from equations (9) and (10), the distance L to the target is dependent on a light intensity at a measurement point and is vulnerable to influences of disturbance light. Although increasing the light intensity of the light source unit in the distance measuring sensor is conceivable in order to reduce the influences of the disturbance light, there are problems in that the sensitivity of the light receiving unit in the distance measuring sensor is saturated, the eyes of the human are adversely affected, and so on.

As technologies for solving the above-described problems, for example, there are technologies as in PTLs 1 and 2.

PTL 1 discloses a technology in which light of colors having mutually different wavelengths is used as measurement light during measurement of a distance to a distance-measurement target. Also, PTL 1 discloses a technology in which a combination of colors that become white when they are mixed together is used as the measurement light.

PTL 2 discloses a technology in which reflection light from a subject, the reflection light being based on first light modulated in a first cycle, and second light modulated in a second cycle are mixed together.

### CITATION LIST

### Patent Literature

[PTL 1] Japanese Unexamined Patent Application Publication No. 2010-169405
[PTL 2] Japanese Unexamined Patent Application Publication No. 2016-53566

### SUMMARY

### Technical Problem

However, in the technology disclosed in PTL 1, when other distance measuring sensors, such as distance measuring sensors 3 and 4, that are the same type as a distance measuring sensor 1 exist right beside or along an extension of the distance measuring sensor 1, as in FIG. 2 showing one example of the positional relationship between the plurality of distance measuring sensors 1, 3, and 4 and a target 2, the technology becomes vulnerable to influences of disturbance light due to irradiation light from the other distance measuring sensors.

Also, the technology disclosed in PTL 2 becomes less vulnerable to influences of disturbance light due to light having a different wavelength, but cannot be made less vulnerable to influences of disturbance light when a similar sensor uses a similar wavelength.

An object of the disclosure is to provide a distance measuring sensor and a distance measuring method that reduce influences of ambient light and disturbance light, such as light of another distance measuring sensor, and that can measure highly accurate distance information.

### Solution to Problem

(1) One embodiment of the disclosure is a TOF-system distance measuring sensor that measures a distance to a target by measuring a time from when a light source unit radiates irradiation light to the target until a light receiving unit receives reflection light reflected by the target. The distance measuring sensor comprises: a light source unit that radiates light to the target as the irradiation light, the light being subjected to primary modulation so that the distance to the target can be measured and being subjected to secondary modulation so that influences of disturbance light are reduced; and a light receiving unit that receives the reflection light subjected to the secondary modulation and that subjects the reflection light subjected to the secondary modulation to secondary demodulation so that influences of disturbance light are reduced.
(2) Also, an embodiment of the disclosure is a distance measuring sensor in which, in addition to the configuration in (1) described above, the light source subjects at least one of polarization, an amplitude, a frequency, and a phase of the light to the primary modulation so that the distance to the target can be measured.
(3) Also, an embodiment of the disclosure is a distance measuring sensor in which, in addition to the configuration in (1) described above, based on a direct spreading system using a PN code in an m-sequence, the light source unit subjects the light to the secondary modulation so that the influences of the disturbance light are reduced.
(4) Also, an embodiment of the disclosure is a distance measuring sensor in which, in addition to the configuration in (1) described above, the light source unit radiates light to the target as the irradiation light, the light being subjected to the secondary modulation by externally supplying a modulation signal.
(5) Also, an embodiment of the disclosure is a distance measuring sensor in which, in addition to the configuration in (1) described above, the light source unit radiates light to the target as the irradiation light, the light being subjected to the secondary modulation by externally supplying a modulation signal to the light subjected to the primary modulation.
(6) An embodiment of the disclosure is a distance measuring sensor that comprises a plurality of light receiving units that is arranged in an array form, in addition to the configuration in (1), (2), (3), (4), or (5) described above.
(7) Also, an embodiment of the disclosure is a TOF-system distance measuring method that measures a distance to a target by measuring a time from when a light source unit radiates irradiation light to the target until a light receiving unit receives reflection light reflected by the target. The distance measuring method includes: a step of radiating light to the target as the irradiation light, the light being subjected to primary modulation so that the distance to the target can be measured and being subjected to secondary modulation so that influences of disturbance light are reduced; and a step of receiving the reflection light subjected to the secondary modulation and subjecting the reflection light subjected to the secondary modulation to secondary demodulation so that influences of disturbance light are reduced.
(8) Also, an embodiment of the disclosure is a TOF-system distance measuring camera that measures a distance to a target by measuring a time from when a light source unit radiates irradiation light to the target until a light receiving unit receives reflection light reflected by the target. The distance measuring camera comprises: a light source unit that radiates light to the target as the irradiation light, the light being subjected to primary modulation so that the distance to the target can be measured and being subjected to secondary modulation so that influences of disturbance light are reduced; and a plurality of light receiving unit that receives the reflection light subjected to the secondary modulation and that subjects the reflection light subjected to the secondary modulation to secondary demodulation so that influences of disturbance light are reduced. The plurality of light receiving units is arranged in an array form.

### Advantageous Effects of Disclosure

According to the disclosure, it is possible to provide a distance measuring sensor and a distance measuring method that reduce influences of ambient light and disturbance light, such as light of another distance measuring sensor, and that can measure highly accurate distance information.

### BRIEF DESCRIPTION OF DRAWINGS

FIG. 1 is a graph showing a relationship between a modulation cycle of an irradiation modulation wave and a reflection modulation wave and light intensities.

FIG. 2 is a diagram showing one example of a positional relationship between a plurality of distance measuring sensors and a target 2.

FIG. 3 is a diagram showing the configuration of a distance measuring sensor according to a first embodiment of the disclosure.

FIG. 4 is a diagram showing the configuration of a light source unit in the distance measuring sensor according to the first embodiment of the disclosure.

FIG. 5 is a diagram for describing secondary modulation based on a direct spreading system using a PN code in an m-sequence.

FIG. 6 shows one example of an m-sequence generating circuit.

FIG. 7 is a diagram showing the configuration of a light receiving unit in the distance measuring sensor according to the first embodiment of the disclosure.

FIG. 8 is diagram for describing secondary modulation and secondary demodulation based on the direct spreading system using a PN code in an m-sequence.

FIG. 9 is a diagram showing the configuration of a distance measuring sensor according to a second embodiment of the disclosure.

FIG. 10 is a diagram showing the configuration of a light source unit in the distance measuring sensor according to the second embodiment of the disclosure.

FIG. 11 is a diagram showing the configuration of a light receiving unit in the distance measuring sensor according to the second embodiment of the disclosure.

FIG. 12 is a diagram showing the configuration of a distance measuring sensor according to a third embodiment of the disclosure.

FIG. 13 is a diagram showing the configuration of a light source unit in the distance measuring sensor according to the third embodiment of the disclosure.

FIG. 14 is diagram showing the configuration of a light receiving unit in the distance measuring sensor according to the third embodiment of the disclosure.

FIG. 15 is a diagram showing the configuration of a distance measuring sensor according to a fourth embodiment of the disclosure.

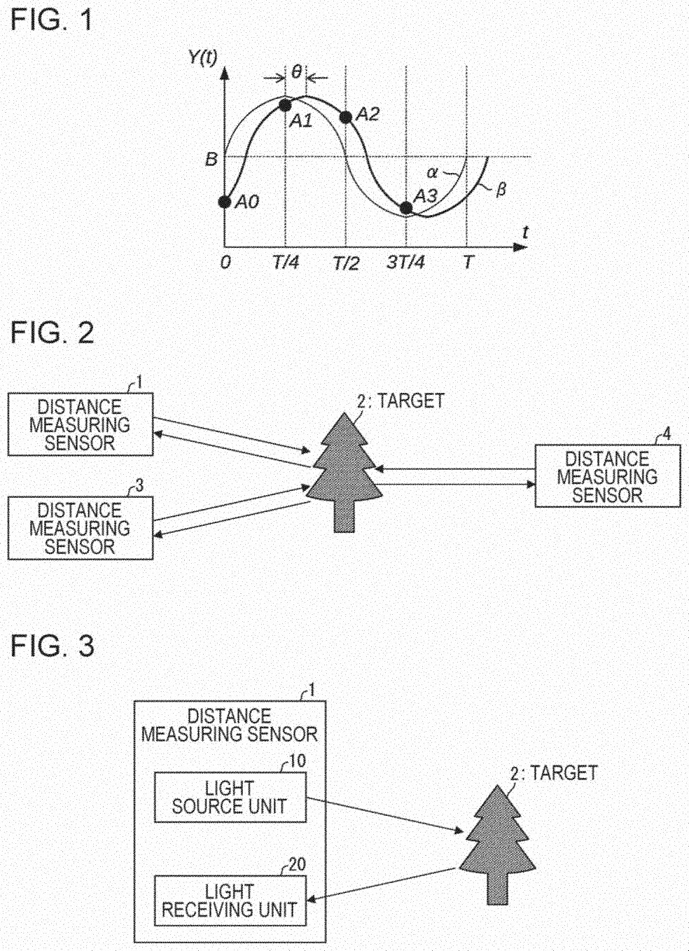

### DESCRIPTION OF EMBODIMENTS

### First Embodiment

A distance measuring sensor 1 according to a first embodiment of the disclosure will be described below using FIGS. 3 to 8.

[Distance Measuring Sensor 1]

FIG. 3 is a diagram showing the configuration of the distance measuring sensor 1 according to the first embodiment of the disclosure. As shown in FIG. 3, the distance measuring sensor 1 is a TOF-system distance measuring sensor that comprises a light source unit 10 and a light receiving unit 20.

In the distance measuring sensor 1, the light source unit 10 radiates irradiation light to a target 2, and the light receiving unit 20 receives reflection light reflected by the target 2. The distance measuring sensor 1 measures a time from when the light source unit 10 radiates the irradiation light to the target 2 until the light receiving unit 20 receives the reflection light reflected by the target 2. That is, the distance measuring sensor 1 measures a round-trip time (a time of flight) of light. Based on the measured round-trip time of the light, the distance measuring sensor 1 calculates a distance to the target 2.

[Light Source Unit 10]

The light source unit 10 radiates light to the target 2 as the irradiation light, the light being subjected to primary modulation so that the distance to the target 2 can be measured and being subjected to secondary modulation by a unique spreading system so that influences of disturbance light are reduced. This reduces influences of ambient light and disturbance light, such as light of another distance measuring sensor and makes it possible to measure highly accurate distance information.

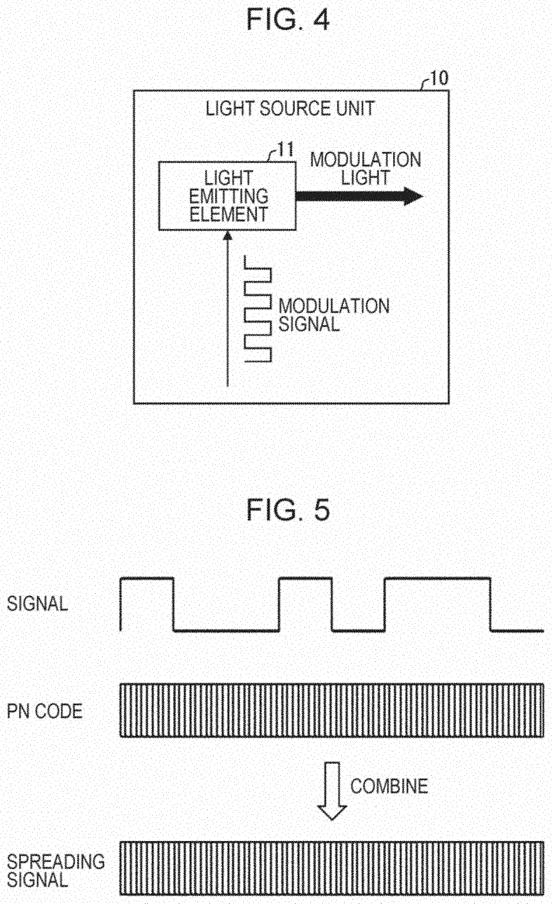

The configuration of the light source unit 10 will be described below in more detail by using FIG. 4. FIG. 4 is a diagram showing the configuration of the light source unit 10 in the distance measuring sensor 1 according to the first embodiment of the disclosure. As shown in FIG. 4, the light source unit 10 modulates light, generated from a light emitting element 11, such as a light-emitting diode (LED) or a semiconductor laser (LD), with a modulation signal. The modulation signal is generated by subjecting a signal of the primary modulation to the secondary modulation. The light emitting element 11 in the light source unit 10 radiates light (modulation light) subjected to the primary modulation and the secondary modulation to the target 2 as the irradiation light. A system in which the light emitting element 11, such as a light-emitting diode (LED) or a semiconductor laser (LD), is used to directly convert changes in the modulation signal into changes in the intensity of irradiation light radiated from the light emitting element 11 is referred to as a direct modulation system.

According to the above-described direct modulation system, it is possible to simplify the configuration of the light source unit 10. Thus, unlike the invention described in PTL 2, the light source unit 10 does not require a relatively large optical system elements, such as two light sources and a dichroic mirror and a half mirror for aligning optical axes of the two light sources, in order to reduce influences of disturbance light. Accordingly, the distance measuring sensor 1 that comprises the light source unit 10 can be preferably utilized for small-size distance measuring sensors that are incorporated into smartphones. Also, since the light emitting element 11, such as a light-emitting diode and a semiconductor laser, allows the light intensity of irradiation light to be changed according to electrical current that is applied, it is possible to easily modulate the amplitude of an irradiation modulation wave.

The light source unit 10 may subject at least one of the polarization, the amplitude, the frequency, and the phase of light to the primary modulation so that the distance to the target 2 can be measured. This makes it possible to subject the light to the modulation so that the distance to the target 2 can be more preferably measured.

Also, based on a direct spreading system using an m-sequence in a PN code, the light source unit 10 may subject the light to the secondary modulation so that influences of disturbance light are reduced. This makes it possible to more easily reduce influences of disturbance light.

The secondary modulation based on the direct spreading system using a PN code in an m-sequence, which is a pseudorandom number sequence, will be described below using FIG. 5. FIG. 5 is a diagram for describing the secondary modulation based on the direct spreading system using a PN code in an m-sequence. As shown in FIG. 5, the light source unit 10 generates a spreading signal by combining a PN code in an m-sequence with a signal of light subjected to the primary modulation. By doing this, the light source unit 10 performs the secondary modulation for modulating the light subjected to the primary modulation into light of the spreading signal.

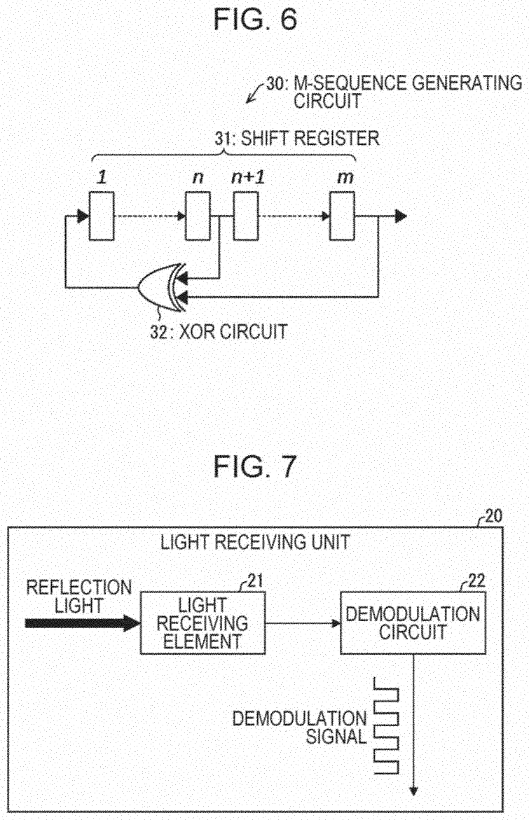

The m-sequence will be described below in more detail by using FIG. 6. FIG. 6 is a diagram showing one example of an m-sequence generating circuit 30. As shown in FIG. 6, the m-sequence generating circuit 30 comprises a shift register 31 and an XOR circuit (exclusive disjunction) 32. The m-sequence generating circuit 30 causes the shift register 31 to shift the signal of the primary modulation bit by bit and performs arithmetic operation by using the XOR circuit 32. By doing this, the m-sequence generating circuit 30 generates an m-sequence whose, autocorrelation becomes an impulse.

[Light Receiving Unit 20]

The light receiving unit 20 receives the reflection light subjected to the secondary modulation and subjects the reflection light subjected to the secondary modulation to secondary demodulation by using a unique spreading system so that influences of disturbance light are reduced. Thereafter, by using a signal of the primary modulation with respect to the reflection light subjected to the secondary demodulation, the light receiving unit 20 calculates a distance to the target 2 which is based on a TOF system.

The reflection light subjected to the secondary modulation is subjected to the secondary demodulation so that influences of disturbance light are reduced, as described above, to thereby reduce influences of ambient light and disturbance light, such as light of another distance measuring sensor, and make it possible to measure highly accurate distance information.

The configuration of the light receiving unit 20 will be described below in more detail by using FIG. 7. FIG. 7 is a diagram showing the configuration of the light receiving unit 20 in the distance measuring sensor 1 according to the first embodiment of the disclosure. As shown in FIG. 7, the light receiving unit 20 receives the reflection light by using a light receiving element 21, such as a photodiode (PD) or a CCD, and converts the reflection light into an electronic signal. By using a demodulation circuit 22, the light receiving unit 20 can retrieve a demodulation signal by demodulating the electrical signal. Here, the demodulation circuit 22 may perform digital demodulation by performing digital signal processing digitized by an AD converter or may perform analog demodulation through diode wave detection.

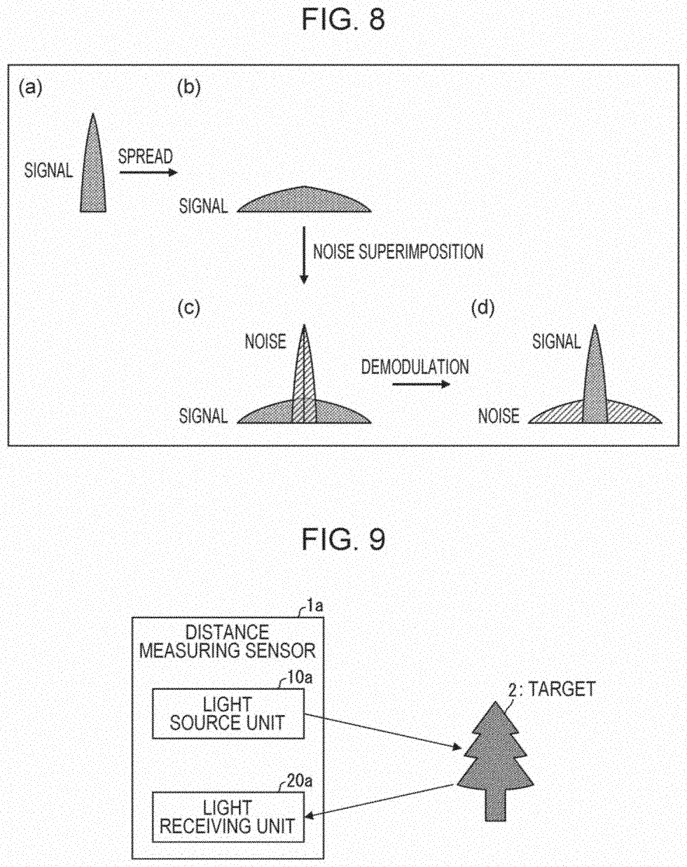

The secondary modulation and the secondary demodulation based on the direct spreading system using a PN code in an m-sequence will be described below in more detail by using FIG. 8. FIG. 8 is a diagram for describing the secondary modulation and the secondary demodulation based on the direct spreading system using a PN code in an m-sequence. The light source unit 10 spreads a narrow-width frequency spectrum of a signal of the light subjected to the primary modulation, as shown in (a) FIG. 8, in a frequency direction by combining a PN code in an m-sequence and subjecting the signal to the secondary modulation, as shown in (b) in FIG. 8. As shown (c) in FIG. 8, noise is superimposed on the irradiation light radiated from the light source unit 10 in a state in which the frequency spectrum extends in the frequency direction in the manner described above. The light receiving unit 20 then receives reflection light based on the irradiation light and reflected by the target 2. Next, the light receiving unit 20 combines a PN code that is analogous to the PN code in the m-sequence used during the secondary modulation with the reflection light, as shown in (d) in FIG. 8. Thus, as shown in (d) in FIG. 8, the reflection light subjected to the secondary modulation is demodulated into a signal that is analogous to the original signal of the light subjected to the primary modulation, because of the property that autocorrelation of a PN code in an m-sequence becomes an impulse. Also, as a result of the above-described secondary demodulation, the light spread with an m-sequence that is different from the m-sequence used during the secondary demodulation by the light receiving unit 20 and uncorrelated disturbance noise are widely spread to thereby reduce the signal level. This makes it possible to reduce influences of light of another distance measuring sensor and disturbance light.

[Distance Measuring Method]

A distance measuring method according to the first embodiment of the disclosure is A TOF-system distance measuring method that measures a distance to a target 2 by measuring a time from when a light source unit 10 radiates irradiation light to the target 2 until a light receiving unit 20 receives reflection light reflected by the target 2. The distance measuring method includes: a step of radiating light to the target 2 as the irradiation light, the light being subjected to primary modulation so that the distance to the target 2 can be measured and being subjected to secondary modulation so that influences of disturbance light are reduced; and a step of receiving the reflection light subjected to the secondary modulation and subjecting the reflection light subjected to the secondary modulation to secondary demodulation so that influences of disturbance light are reduced.

### Second Embodiment

Next, a distance measuring sensor 1a according to a second embodiment of the disclosure will be described using FIGS. 9 to 11. For convenience of description, members having the same functions as the members described in the first embodiment are denoted by the same reference numerals, and descriptions thereof are omitted.

[Distance Measuring Sensor 1a]

FIG. 9 is a diagram showing the configuration of the distance measuring sensor 1a according to the second embodiment of the disclosure. As shown in FIG. 9, the distance measuring sensor 1a comprises a light source unit 10a and a light receiving unit 20a, instead of the light source unit 10 and the light receiving unit 20 in the distance measuring sensor 1 according to the first embodiment. Except for this point, the distance measuring sensor 1a has a configuration that is analogous to that of the distance measuring sensor 1 according to the first embodiment.

[Light Source Unit 10a]

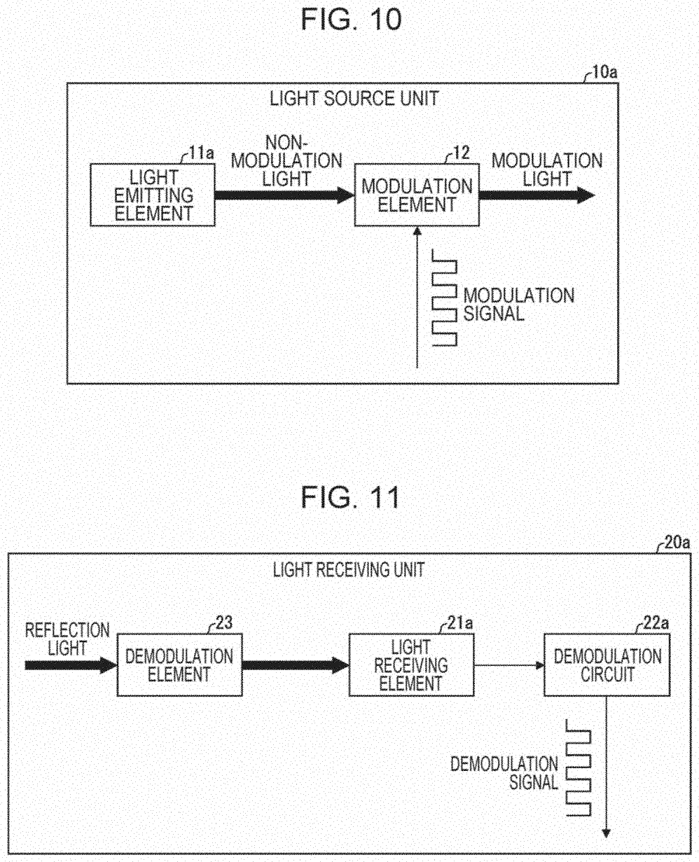

The configuration of the light source unit 10a will be described below using FIG. 10. FIG. 10 is a diagram showing the configuration of the light source unit 10a in the distance measuring sensor 1a according to the second embodiment of the disclosure. As shown in FIG. 10, the light source unit 10a further comprises a modulation element 12 in addition to a light emitting element 11a instead of the light emitting element 11 in the first embodiment. Except for this point, the light source unit 10a has a configuration that is analogous to that of the light source unit 10 in the first embodiment.

The light source unit 10a controls the modulation element 12 by causing unmodulated light (non-modulation light) to be generated from the light emitting element 11a, such as a light-emitting diode (LED) or a semiconductor laser (LD), and using a modulation signal. The modulation signal can be generated by subjecting the signal of the primary modulation to the secondary modulation. The light source unit 10a radiates modulation light (light) to the target 2 as irradiation light, the modulation light being subjected to the secondary modulation by externally supplying the modulation signal. A system in which a modulation signal is externally supplied to non-modulation light generated from the light emitting element 11a to thereby modulate the non-modulation light supplied to the modulation element 12 into modulation light, as described above, is referred to as “external modulation”. The external modulation is suitable for high-speed switching.

(Modulation Element 12)

Elements of lithium niobate (LiNbO₃) and so on which utilize an electro-optic effect in which modulation is performed using an electric field are available as the modulation element 12. Elements of gallium phosphorous, germanium, and so on which utilize an acousto-optic effect in which modulation is performed using ultrasonic waves are also available as the modulation element 12. In addition, various elements utilizing a magneto-optical effect, a thermo-optical effect, and a nonlinear optical effect are available as the modulation element 12. By changing the refractive index of light, the modulation element 12 can easily subject at least one of the polarization, the amplitude, the frequency, and the phase of light to the primary modulation so that a distance to a target can be measured.

[Light Receiving Unit 20a]

The configuration of the light receiving unit 20a will be described below using FIG. 11. FIG. 11 is a diagram showing the configuration of the light receiving unit 20a in the distance measuring sensor 1a according to the second embodiment of the disclosure. As shown in FIG. 11, the light receiving unit 20a comprises a light receiving element 21a and a demodulation circuit 22a, instead of the light receiving element 21 and the demodulation circuit 22 in the first embodiment, and further comprises a demodulation element 23. Except for this point, the light receiving unit 20a has a configuration that is analogous to that of the light receiving unit 20 in the first embodiment.

The demodulation element 23 subjects the reflection light to the secondary demodulation while it is in a reflection light state. The light receiving element 21a, such as a photodiode (PD) or a CCD, receives the reflection light subjected to the secondary demodulation and converts the reflection light into an electrical signal. The demodulation circuit 22a can retrieve the demodulation signal from the electrical signal. Here, the demodulation circuit 22a may perform digital demodulation by performing digital signal processing digitized by an AD converter or may perform analog demodulation through diode wave detection.

### Third Embodiment

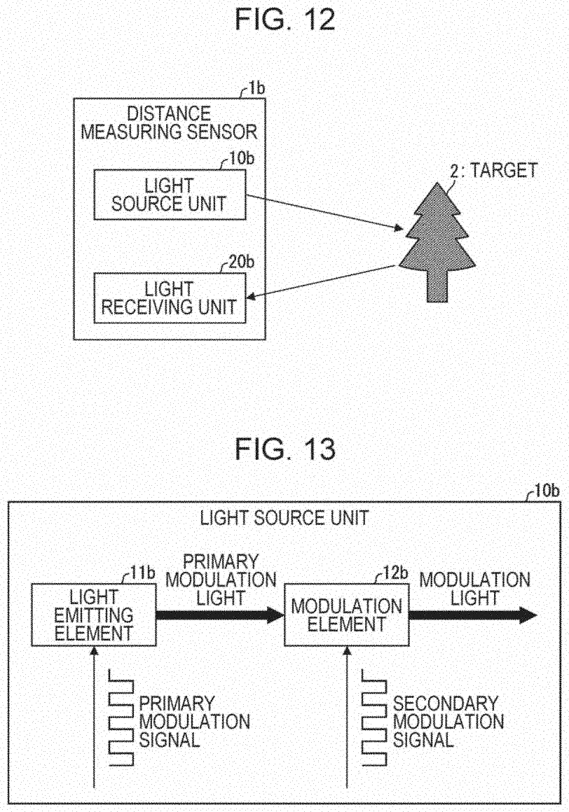

Next, a distance measuring sensor 1b according to a third embodiment of the disclosure will be described using FIGS. 12 to 14. For convenience of description, members having the same functions as the members described in the above embodiments are denoted by the same reference numerals, and descriptions thereof are omitted.

[Distance Measuring Sensor 1b]

FIG. 12 is a diagram showing the configuration of the distance measuring sensor 1b according to the third embodiment of the disclosure. As shown in FIG. 12, the distance measuring sensor 1b comprises a light source unit 10b and a light receiving unit 20b, instead of the light source unit 10a and the light receiving unit 20a in the distance measuring sensor 1a according to the second embodiment. Except for this point, the distance measuring sensor 1b has a configuration that is analogous to that of the distance measuring sensor 1a according to the second embodiment.

[Light Source Unit 10b]

The configuration of the light source unit 10b will be described below using FIG. 13. FIG. 13 is a diagram showing the configuration of the light source unit 10b in the distance measuring sensor 1b according to the third embodiment of the disclosure. As shown in FIG. 13, the light source unit 10b comprises a light emitting element 11b and a modulation element 12b, instead of the light emitting element 11a and the modulation element 12. Except for this point, the light source unit 10b has a configuration that is analogous to that of the light source unit 10a in the second embodiment.

The light source unit 10b supplies a primary modulation signal to the light emitting element 11b, such as a light-emitting diode (LED) or a semiconductor laser (LD), to thereby subject light generated from the light emitting element 11b to the primary modulation. The light emitting element 11b generates primary modulation light, and the light source unit 10b supplying a secondary modulation signal to the modulation element 12b to thereby subject the primary modulation light to the secondary modulation. Thus, the light source unit 10b externally supplies the secondary modulation signal to the primary modulation light generated from the light emitting element 11b. By doing this, the light source unit 10b performs external modulation for modulating the primary modulation light, supplied to the modulation element 12b, into modulation light subjected to the secondary modulation. The light source unit 10b radiates the modulation light (light) to the target 2 as the irradiation light, the modulation light being subjected to the secondary modulation by externally supplying the modulation signal to the primary modulation light (the light subjected to the primary modulation).

[Light Receiving Unit 20b]

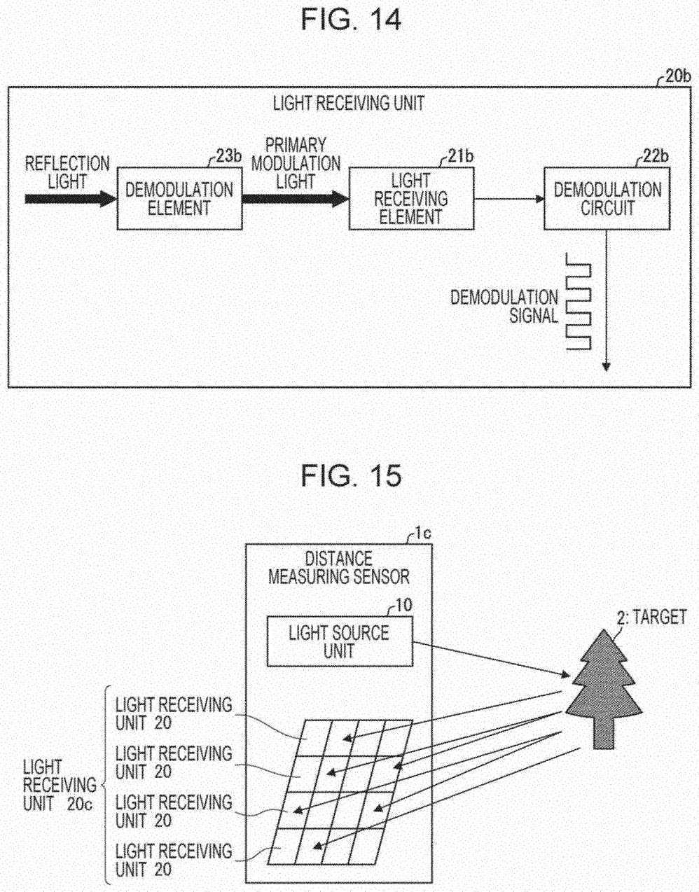

The configuration of the light receiving unit 20b will be described below using FIG. 14. FIG. 14 is a diagram showing the configuration of the light receiving unit 20b in the distance measuring sensor 1b according to the third embodiment of the disclosure. As shown in FIG. 14, the light receiving unit 20b comprises a light receiving element 21b, a demodulation circuit 22b, and a demodulation element 23b, instead of the light receiving element 21, the demodulation circuit 22, and the demodulation element 23. Except for this point, the light receiving unit 20b has a configuration that is analogous to that of the light receiving unit 20a in the second embodiment.

The demodulation element 23b subjects the reflection light to the primary demodulation while it is in a reflection light state. The light receiving element 21b, such as a photodiode (PD) or a CCD, receives primary demodulation light, subjected to the primary demodulation, and converts the primary demodulation light into an electrical signal. The demodulation circuit 22b can retrieve a demodulation signal by subjecting the electrical signal to the secondary demodulation. Here, the demodulation circuit 22b may perform digital demodulation by performing digital signal processing digitized by an AD converter or may perform analog demodulation through diode wave detection.

Although combinations of the direct and external modulation/demodulation, such as a combination of the direct modulation and the direct demodulation, a combination of the external modulation and the external demodulation, have been described above in the embodiments described above, the disclosure is not limited to those combinations. In the disclosure, for example, the external modulation and the direct demodulation may be combined together, or the direct modulation and the external demodulation may be combined together.

### Fourth Embodiment

Next, a distance measuring sensor 1c according to a fourth embodiment of the disclosure will be described below using FIG. 15. For convenience of description, members having the same functions as the members described in the above embodiments are denoted by the same reference numerals, and descriptions thereof are omitted.

[Distance Measuring Sensor 1c]

FIG. 15 is a diagram showing the configuration of the distance measuring sensor 1c according to the fourth embodiment of the disclosure. As shown in FIG. 15, the distance measuring sensor 1c comprises a light receiving unit 20c, instead of the light receiving unit 20 in the distance measuring sensor 1 according to the first embodiment. Except for this point, the distance measuring sensor 1c has a configuration that is analogous to that of the distance measuring sensor 1 according to the first embodiment.

[Light Receiving Unit 20c]

As shown in FIG. 15, the light receiving unit 20c comprises a plurality of light receiving units 20 arranged in an array form. The light receiving unit 20c in which the plurality of light receiving units 20 (for example, CCDs, CMOS imagers, and so on) is arranged in an array form receives reflection light reflected by a target 2 after the light source unit 10 radiates irradiation light to the target 2. The light receiving unit 20c can create a distance map by calculating distances to the target 2 for the respective light receiving units 20.

[Modification]

Since a distance map can be created as in the examples described above, the distance measuring sensor 1c can also function as a distance measuring camera. That is, the distance measuring camera is a TOF-system distance measuring camera that measures a distance to a target 2 by measuring a time from when a light source unit 10 radiates irradiation light to the target 2 until a light receiving unit 20c receives reflection light reflected by the target 2. The distance measuring camera comprises: a light source unit 10 that radiates light to the target 2 as the irradiation light, the light being subjected to primary modulation so that the distance to the target 2 can be measured and being subjected to secondary modulation so that influences of disturbance light are reduced; and a plurality of light receiving units 20 that receives the reflection light subjected to the secondary modulation and that subjects the reflection light subjected to the secondary modulation to secondary demodulation so that influences of disturbance light are reduced. The plurality of light receiving units 20 is arranged in an array form.

The disclosure is not limited to each embodiment described above, various changes are possible within the scope recited in the claims, and embodiments obtained by appropriately combining the technical means respectively disclosed in the different embodiments are also encompassed by the technical scope of the disclosure. In addition, new technical features can be formed by combining the technical means respectively disclosed in the embodiments.

1. A TOF-system distance measuring sensor that measures a distance to a target by measuring a time from when a light source unit radiates irradiation light to the target until a light receiving unit receives reflection light reflected by the target, the distance measuring sensor comprising:
a light source unit that radiates light to the target as the irradiation light, the light being subjected to primary modulation so that the distance to the target can be measured and being subjected to secondary modulation so that influences of disturbance light are reduced; and
a light receiving unit that receives the reflection light subjected to the secondary modulation and that subjects the reflection light subjected to the secondary modulation to secondary demodulation so that influences of disturbance light are reduced.

2. The distance measuring sensor according to claim 1, wherein the light source subjects at least one of polarization, an amplitude, a frequency, and a phase of the light to the primary modulation so that the distance to the target can be measured.

3. The distance measuring sensor according to claim 1, wherein, based on a direct spreading system using a PN code in an m-sequence, the light source unit subjects the light to the secondary modulation so that the influences of the disturbance light are reduced.

4. The distance measuring sensor according to claim 1, wherein the light source unit radiates light to the target as the irradiation light, the light being subjected to the secondary modulation by externally supplying a modulation signal.

5. The distance measuring sensor according to claim 1, wherein the light source unit radiates light to the target as the irradiation light, the light being subjected to the secondary modulation by externally supplying a modulation signal to the light subjected to the primary modulation.

6. The distance measuring sensor according to claim 1, comprising a plurality of light receiving units that is arranged in an array form.

7. A TOF-system distance measuring method that measures a distance to a target by measuring a time from when a light source unit radiates irradiation light to the target until a light receiving unit receives reflection light reflected by the target, the distance measuring method including:
a step of radiating light to the target as the irradiation light, the light being subjected to primary modulation so that the distance to the target can be measured and being subjected to secondary modulation so that influences of disturbance light are reduced; and
a step of receiving the reflection light subjected to the secondary modulation and subjecting the reflection light subjected to the secondary modulation to secondary demodulation so that influences of disturbance light are reduced.

8. A TOF-system distance measuring camera that measures a distance to a target by measuring a time from when a light source unit radiates irradiation light to the target until a light receiving unit receives reflection light reflected by the target, the distance measuring camera comprising:
a light source unit that radiates light to the target as the irradiation light, the light being subjected to primary modulation so that the distance to the target can be measured and being subjected to secondary modulation so that influences of disturbance light are reduced; and
a plurality of light receiving unit that receives the reflection light subjected to the secondary modulation and that subjects the reflection light subjected to the secondary modulation to secondary demodulation so that influences of disturbance light are reduced,
wherein the plurality of light receiving units is arranged in an array form.
